(19) United States
(12) Patent Application Publication
(10) Pub. No.: US 2021/0381495 A1
(43) Pub. Date: Dec. 9, 2021

(54) WIND TURBINE NACELLE MOUNTED COOLING SYSTEM

(71) Applicant: NISSENS COOLING SOLUTIONS A/S, Horsens (DK)

(72) Inventors: Morten MØRKHOLT, Horsens (DK); Mikkel JENSEN, Horsens (DK)

(21) Appl. No.: 17/299,974

(22) PCT Filed: Dec. 6, 2019
(86) PCT No.: PCT/EP2019/083991

§ 371 Date: Jun. 4, 2021

(30) Foreign Application Priority Data
Dec. 7, 2018 (EP) 18211111.2
Mar. 6, 2019 (EP) 19160954.4
Mar. 15, 2019 (EP) 19163072.2

(51) Int. Cl. F03D 80/60

(52) U.S. Cl. CPC F03D 80/60; F05B 2260/232; F05B 2250/183

(57) ABSTRACT

The present invention relates to a wind turbine nacelle mounted cooling system configured to be mounted on a first face of a nacelle of a wind turbine, the nacelle being rotably connected with a tower so that the nacelle is positioned in relation to a wind direction, the first face having a longitudinal extension substantially corresponding to the wind direction, the cooling system comprising a projected wind area when in operation extending substantially in a perpendicular direction from the first face, the projected wind area is defined by at least a first cooling module having a first cooling area, the projected wind area is defined as a two-dimensional area by projecting a shape of the cooling module on to an arbitrary plane when seen from the wind direction, wherein at least a part of the first cooling area is arranged with an angle different from 90 degrees in relation to the longitudinal extension of the first face of the nacelle.

The present invention relates to a wind turbine nacelle mounted cooling system configured to be mounted on a first face of a nacelle of a wind turbine, the nacelle being rotably connected with a tower so that the nacelle is positioned in relation to a wind direction, the first face having a longitudinal extension substantially corresponding to the wind direction.

A wind turbine converts wind power into electrical energy by using a generator placed among other components in the nacelle of the wind turbine. When the generator converts energy, heat is generated by the components.

When the temperature of the components is elevated, the efficiency, with which the conversion occurs, is substantially decreased. In order to cool the components, the walls and the air surrounding the components are cooled down by means of a cooling device positioned on top of the nacelle. Thus, the cool outside air passes through the cooling device and cools a cooling fluid within the cooling device, the fluid being subsequently used to cool the walls of the components in the nacelle or the air surrounding the components.

Since the sizes and yield of the wind turbines increases, the cooling need increases as well, which then influences on the sizes of the cooling devices to be positioned on the nacelles. Even though the sizes of the nacelle increase as well, it may be difficult to provide cooling devices having sufficient cooling capacity on the nacelles.

It is an object of the present invention to wholly or partly overcome the above disadvantages and drawbacks of the prior art. More specifically, it is an object to provide an improved wind turbine nacelle mounted cooling system having enhanced cooling effect and cooling capacity.

The above objects, together with numerous other objects, advantages and features, which will become evident from the below description, are accomplished by a solution in accordance with the present invention by a wind turbine nacelle mounted cooling system configured to be mounted on a first face of a nacelle of a wind turbine, the nacelle being rotably connected with a tower so that the nacelle is positioned in relation to a wind direction, the first face having a longitudinal extension substantially corresponding to the wind direction, the cooling system comprising:
a projected wind area when in operation extending substantially in a perpendicular direction from the first face, the projected wind area is defined by at least a first cooling module having a first cooling area, the projected wind area is defined as a two-dimensional area by projecting a shape of the cooling module on to an arbitrary plane when seen from the wind direction,
wherein at least a part of the first cooling area is arranged with an angle different from 90 degrees in relation to the longitudinal extension of the first face of the nacelle.

The above objects, together with numerous other objects, advantages and features, which will become evident from the below description, are also accomplished by a solution in accordance with the present invention by a wind turbine nacelle mounted cooling system configured to be mounted on a first face of a nacelle of a wind turbine, the nacelle being rotably connected with a tower so that the nacelle is positioned in relation to a wind direction, the first face having a longitudinal extension substantially corresponding to the wind direction, the cooling system comprising:
a projected wind area when in operation extending substantially in a perpendicular direction from the first face, the projected wind area is defined by at least a first cooling module having a first cooling area, the projected wind area is defined as a two-dimensional area by projecting a shape of the cooling module on to an arbitrary plane when seen from the wind direction,
wherein the first cooling area is defined by a height and a width providing an effective cooling area, the effective cooling area being larger than the projected wind area.

In the prior art solutions, the projected wind area of the wind turbine nacelle mounted cooling systems seen from the wind direction is equal to the effective cooling area of the cooling area of the cooling module(s) arranged to be extending up and away from the first face of the nacelle. Hence, the inventors of the present invention have realised that it is possible to enhance the effective cooling area without enhancing the projected wind area. Thus, by the present invention, the overall cooling capacity of the wind turbine nacelle mounted cooling system may be considerably greater than the known cooling systems.

In addition, the wind turbine nacelle mounted cooling system according to the invention is securely fastened to the first face of the nacelle and is thereby moving with the nacelle when the nacelle is rotated in relation to the wind direction. Hence, the wind turbine nacelle mounted cooling system according to the invention is configured to be moved and positioned in relation to the wind direction via the movement of the nacelle.

Furthermore, straight lines taken along the extremities of the cooling module(s) together define a three-dimensional volume of the cooling system.

The three-dimensional volume is larger than a cooling module volume defined by a height, a width, and a depth of the cooling module(s).

Also, the entire first cooling area may be arranged with an angle different from 90 degrees in relation to the longitudinal extension.

Moreover, the first face may have a transverse extension being perpendicular to the longitudinal extension of the nacelle/first face, the cooling system comprises a second cooling module having a second cooling area, the first cooling module and the second cooling module being arranged adjacent to each other in the transverse extension.

Further, the second cooling area may be arranged with an angle different from 90 degrees in relation to the longitudinal extension of the first face of the nacelle.

Additionally, the first cooling area and the second cooling area may together define the effective cooling area, the effective cooling area being larger than the projected wind area.

Furthermore, the effective cooling area may be 3% larger than the projected wind area, preferably 5% larger than the projected wind area, more preferably 10% larger than the projected wind area, most preferably more than 15% larger than the projected wind area.

Advantageously, the effective cooling area may be more than 30% larger than the projected wind area.

Moreover, the projected wind area may have an angle α of substantially 90 degrees in relation to the wind direction, and at least a part of the first cooling area is arranged with an angle being different from the angle α of the projected wind area.

The 90 degrees angle in relation to the longitudinal extension may be seen from a top view of the face.

Additionally, the 90 degrees angle in relation to the longitudinal extension may be in a plane being parallel to the first face.

Also, the 90 degrees angle in relation to the longitudinal extension may correspond to the angle α of the projected wind area.

Furthermore, the cooling module may be extending perpendicularly from the first face of the nacelle.

Moreover, the first cooling area may not be perpendicular to the wind direction.

In addition, the angle may be different from a plane being perpendicular to the longitudinal extension of the first face of the nacelle with between 2 to 88 degrees, preferably between 14 to 86 degrees, more preferably between 20 to 65 degrees.

Moreover, the angle of the first cooling area and the angle of the second cooling area may define a mutual angle between the first cooling area and the second cooling area.

Also, the first cooling area and the second cooling area when being angled may define a V when seen from above.

Further, a plurality of cooling modules may be arranged adjacent to each other in the transverse extension of the first face.

Additionally, each cooling module may have a cooling area, each cooling area having an angle different from 90 degrees in relation to the longitudinal extension of the first face of the nacelle.

Furthermore, the plurality of cooling modules may define a zig-zag pattern when seen from above.

In addition, the first cooling area may have a different angle in relation to the second cooling area.

Moreover, all cooling areas of the cooling modules may have different angles in relation to the longitudinal extension of the first face.

Also, the first cooling module and the second cooling module may each be connected with the first face.

Further, two adjacent cooling modules may be connected to each other by one or more connection parts.

Additionally, a space may be created between two adjacent cooling modules, wherein an additional cooling module is arranged in the space.

In addition, each cooling module may be connected with a cooling circuit configured to circulate a cooling medium so that the cooling medium may flow in the cooling module and the cooling circuit.

Moreover, the cooling system may be a passive cooling system.

Furthermore, the angle of the cooling area may be adjusted under operation.

Also, the angle of the cooling area may be different along the cooling area.

Further, the first cooling area may have a curved extension, the curved extension having a plurality of tangent lines along the curved extension, each tangent line defining an angle being different from 90 degrees in relation to the longitudinal extension of the first face of the nacelle.

The cooling module may comprise at least one heat exchanger core configured to define the cooling area of the cooling module, the heat exchanger core having a core extension extending from an upwind side to a downwind side, the core extension is arranged substantially parallelly to the wind direction.

Moreover, the cooling module may comprise a plurality of heat exchanger cores arranged in a row extending along the cooling area.

The heat exchanger cores may be arranged substantially vertically or substantially horizontally.

Also, the heat exchanger cores may be arranged with a mutual distance between them, defining a space between them, and air fins may be arranged in the space.

Furthermore, the air fins may be arranged substantially parallelly to the wind direction.

The heat exchanger cores may comprise a fluid tube wherein the cooling medium is configured to flow.

Additionally, the cooling module may be a plate and bar cooler.

Moreover, an air guide may be arranged between the first cooling module and the second cooling module.

Furthermore, a first row of cooling modules may be arranged adjacent to each other in the transverse extension of the first face, and a second row of cooling modules may be arranged adjacent to each other in the transverse extension of the first face in a distance from the first row in the longitudinal extension.

Also, each cooling module of each row may have a cooling area, each cooling area having an angle being substantially 90 degrees in relation to the longitudinal extension of the first face of the nacelle.

In addition, each cooling module of each row may have a cooling area, each cooling area having an angle different from 90 degrees in relation to the longitudinal extension of the first face of the nacelle.

Moreover, each cooling module of the first row may have a cooling area, each cooling area having an angle different from 90 degrees in relation to the longitudinal extension of the first face of the nacelle, and each cooling module of the second row may have a cooling area, each cooling area having an angle being substantially 90 degrees in relation to the longitudinal extension of the first face of the nacelle, or vice versa, or a combination thereof.

Also, the one or more of the cooling modules of the first row may be arranged with a transverse space from an adjacent cooling module so that wind can pass through the transverse space to the subsequent row of cooling modules.

Furthermore, at least one of the cooling modules of the second row may be arranged opposite the transverse space of the first row seen from the wind direction.

Moreover, a third row of cooling modules may be arranged adjacent to each other in the transverse extension of the first face in a distance from the second row in the longitudinal extension.

Additionally, the cooling modules of the first row have a first height and the cooling modules of the second row have a second height, the second height being larger than the first height.

Finally, the present invention also relates to a wind turbine having a wind turbine nacelle mounted cooling system as described above.

The invention and its many advantages will be described in more detail below with reference to the accompanying schematic drawings, which for the purpose of illustration show some non-limiting embodiments and in which:

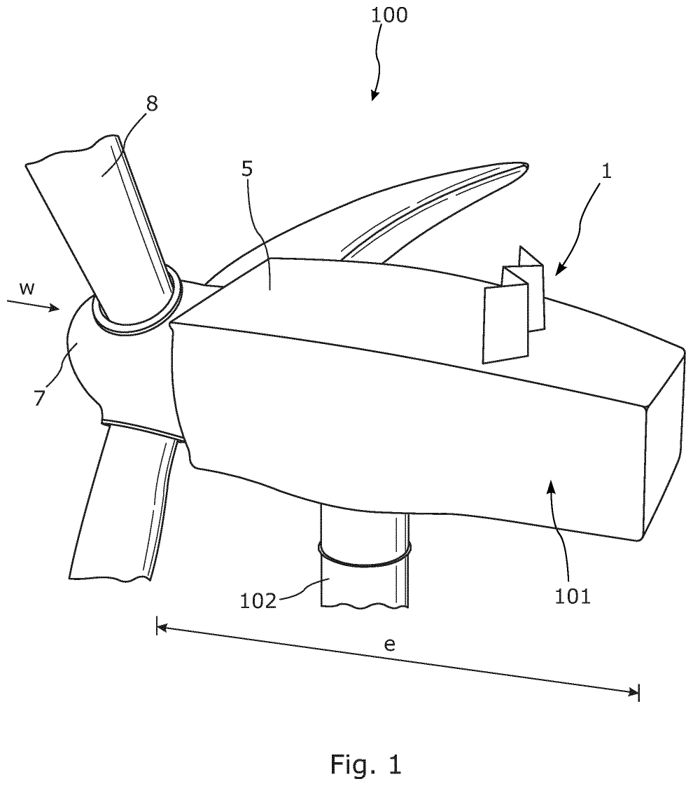

FIG. 1 shows a wind turbine with a wind turbine nacelle mounted cooling system according to the invention,

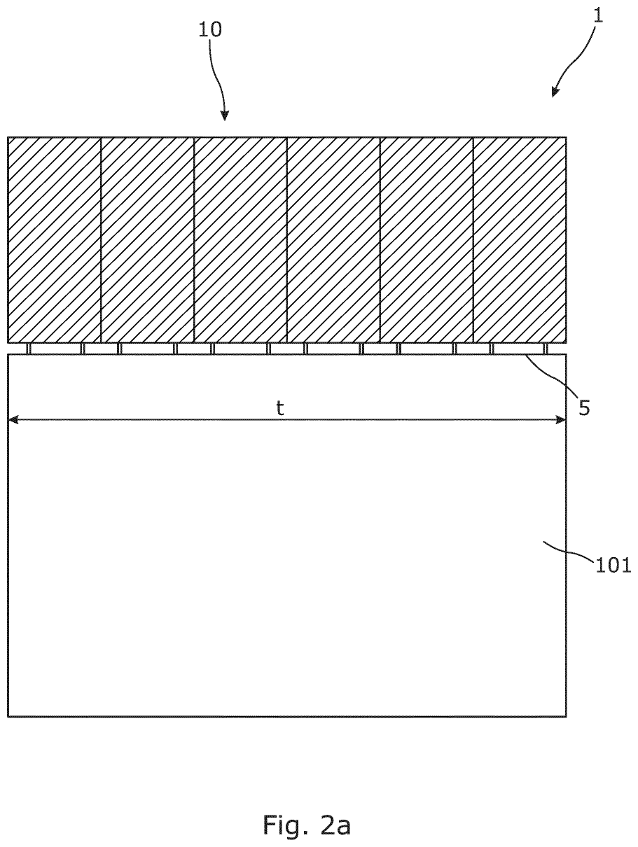

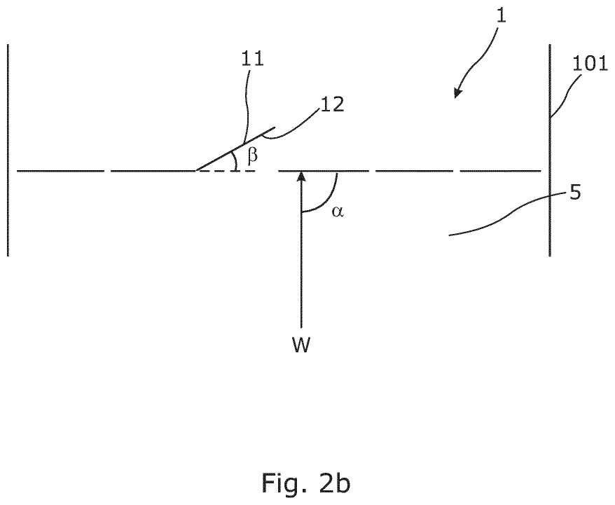

FIG. 2a shows a projected wind area of the cooling system,

FIG. 2b shows a cooling system positioned on the first face of the nacelle,

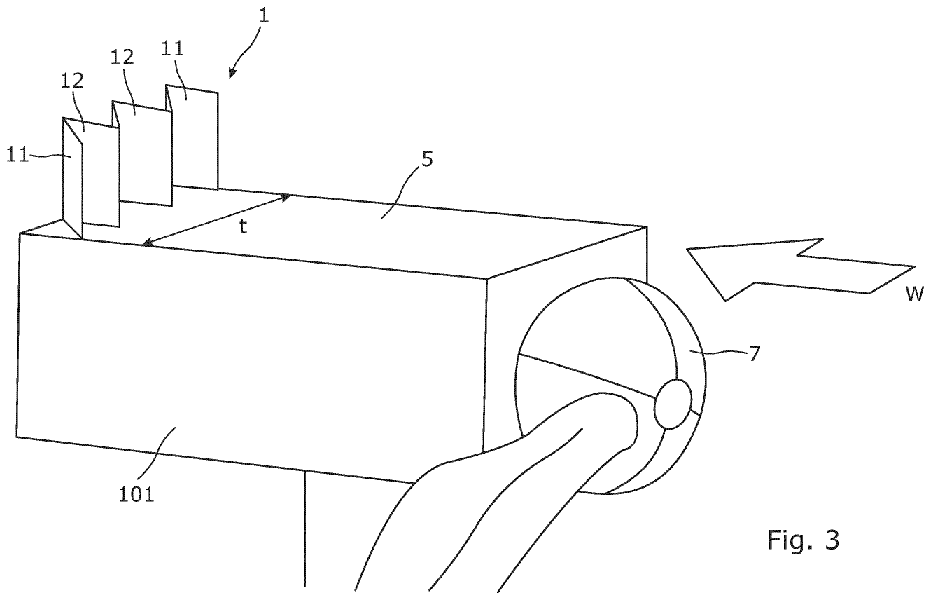

FIG. 3 shows a cooling system positioned on the first face of the nacelle,

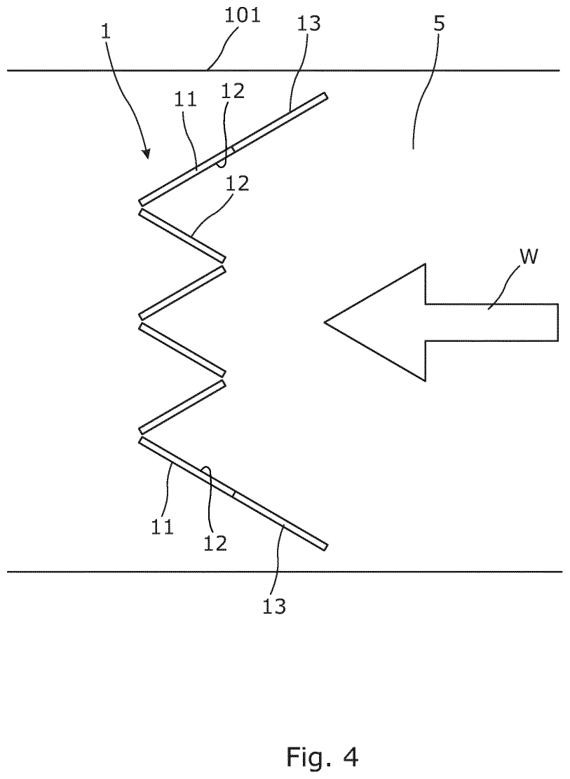

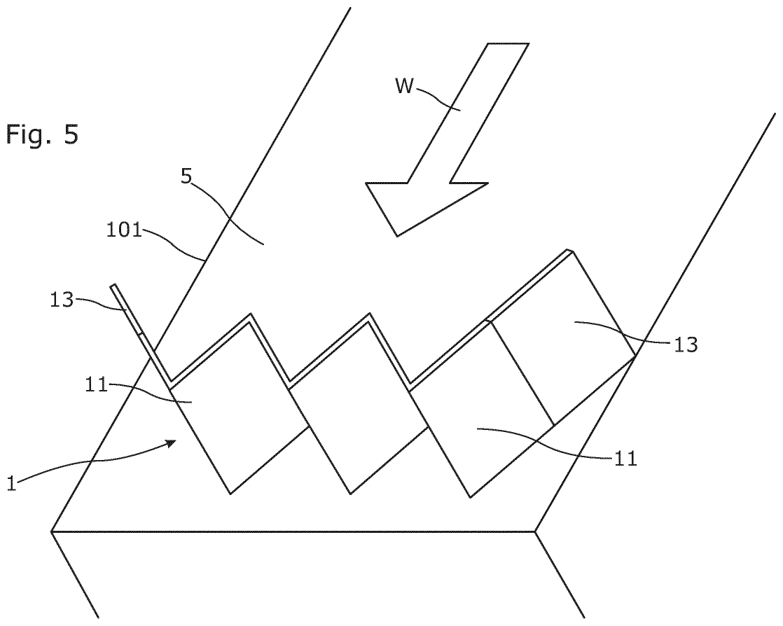

FIGS. 4-5 show another cooling system positioned on the first face of the nacelle,

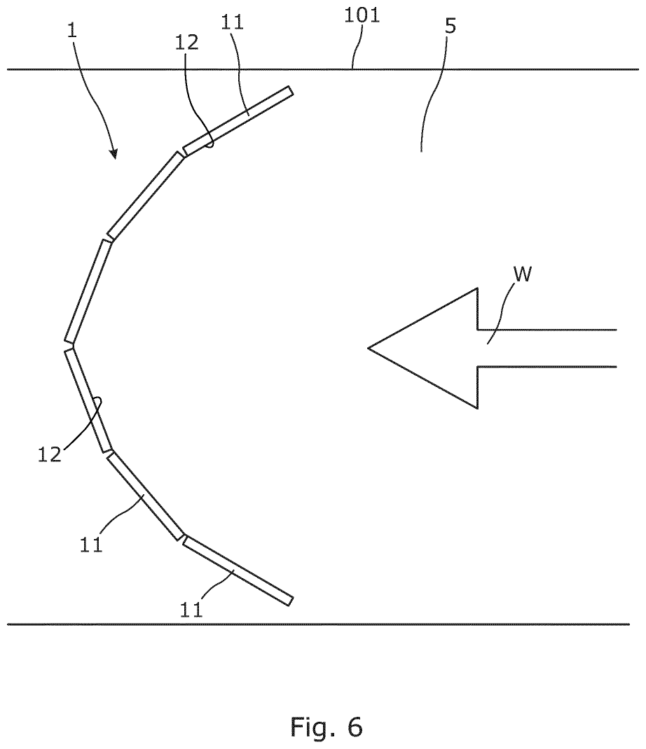

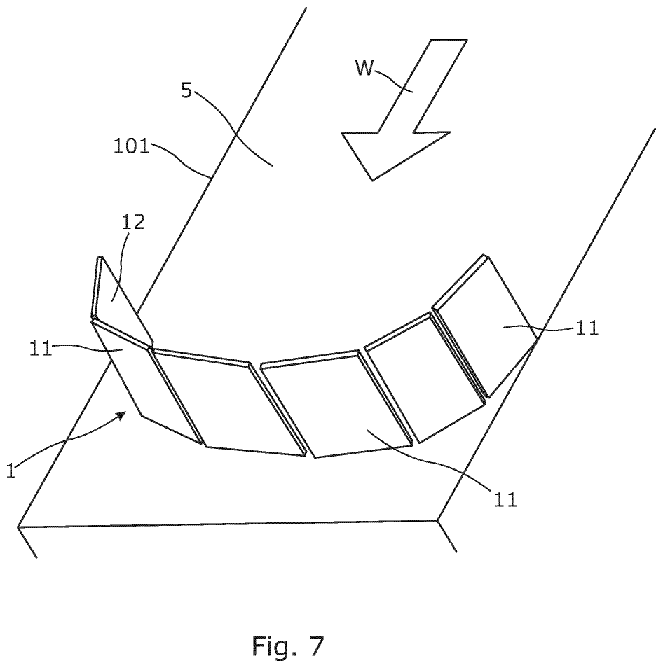

FIGS. 6-7 show an additional cooling system positioned on the first face of the nacelle,

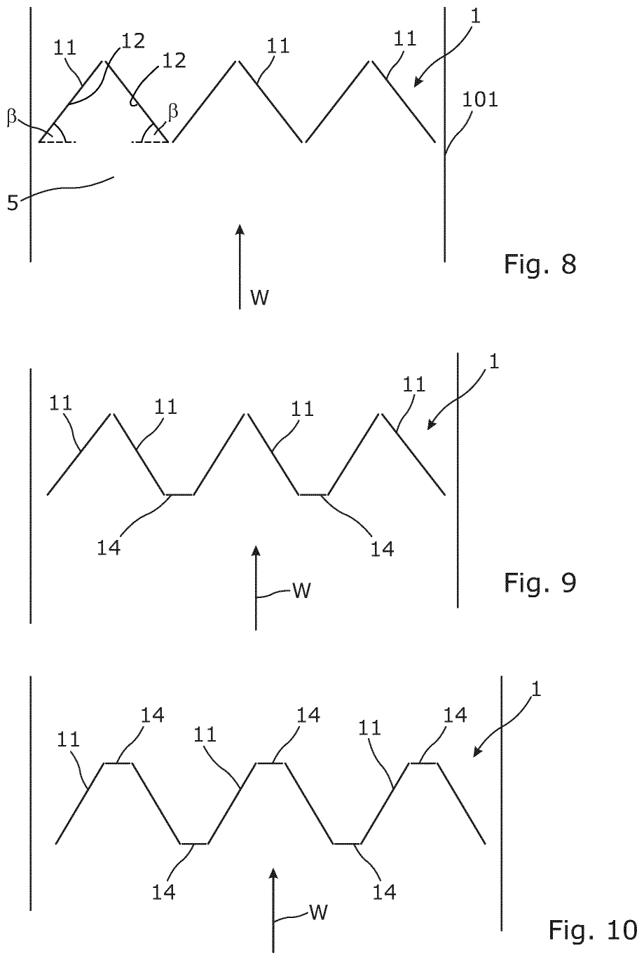

FIGS. 8-12 show different configurations of the cooling system,

FIGS. 13-15 show yet another cooling system positioned on the first face of the nacelle,

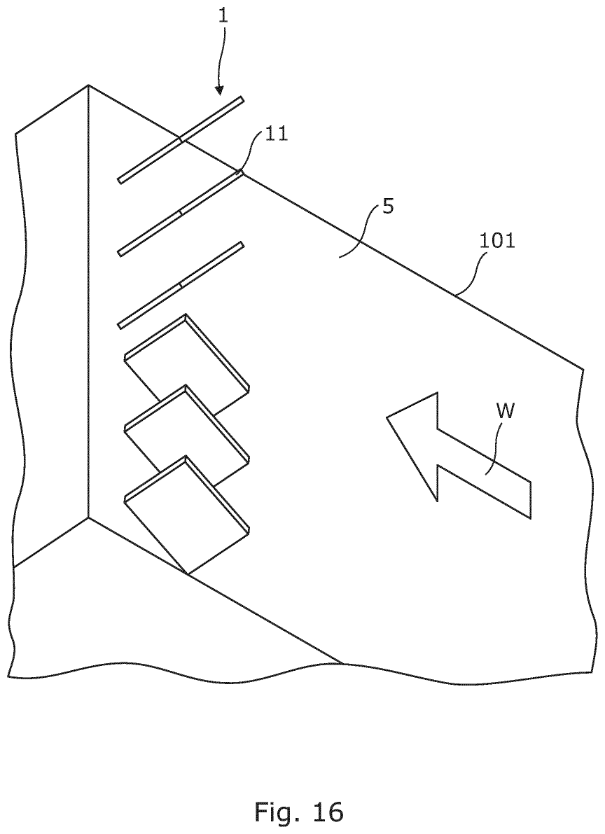

FIGS. 16-17 show an additional cooling system positioned on the first face of the nacelle,

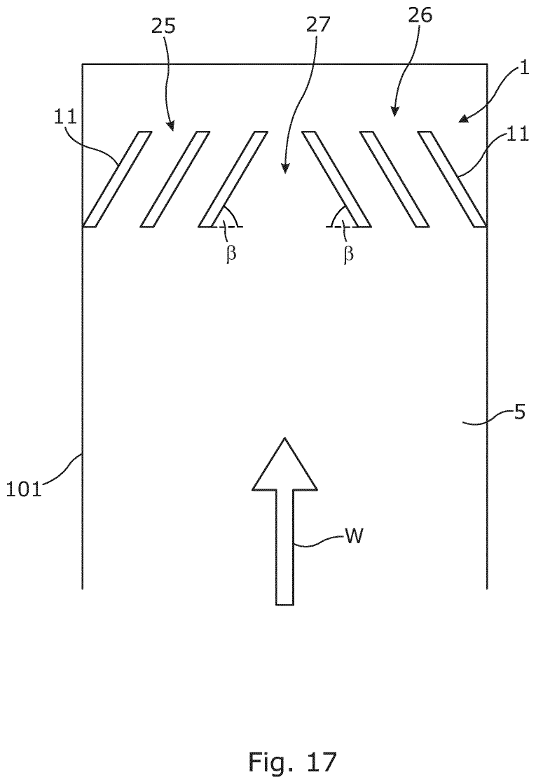

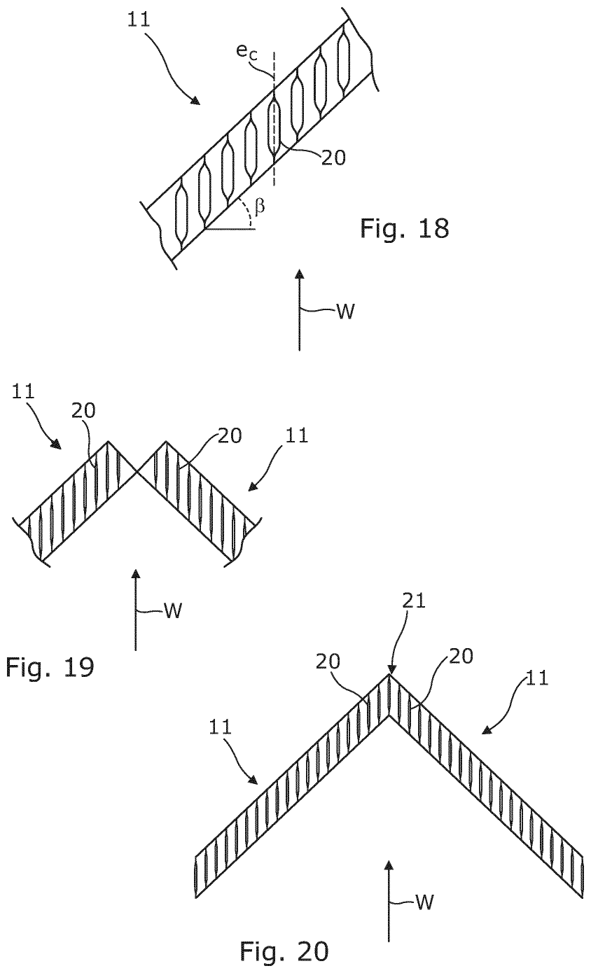

FIGS. 18-20 show different embodiments of a cooling module having heat exchanger cores,

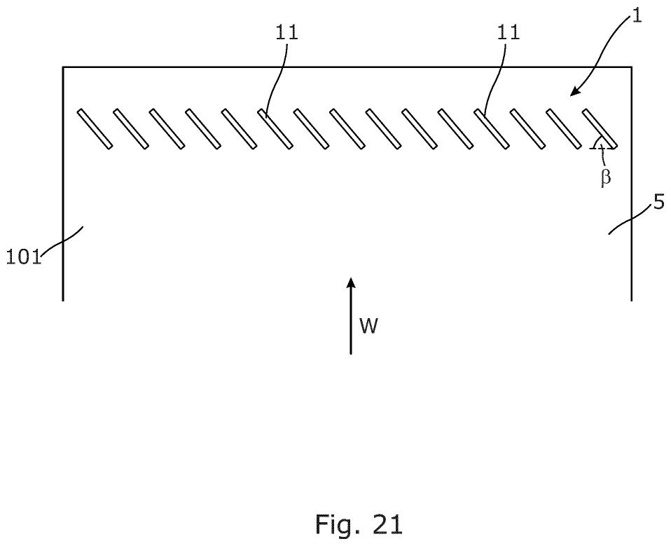

FIG. 21 shows another embodiment of a cooling system positioned on the first face of the nacelle,

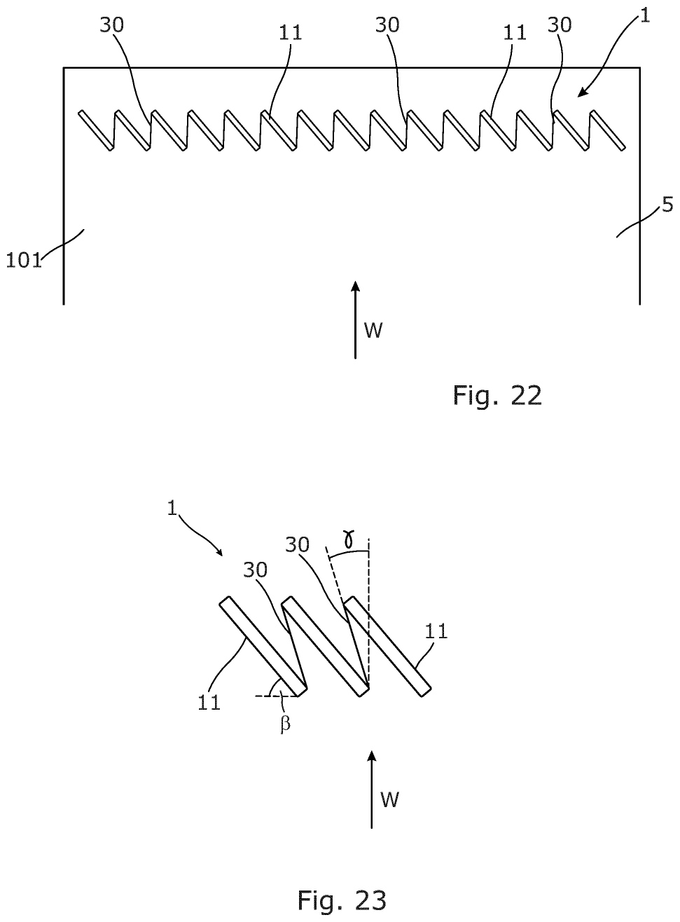

FIG. 22 shows another embodiment of FIG. 21 having air guides arranged between the cooling modules,

FIG. 23 shows another arrangement of air guides,

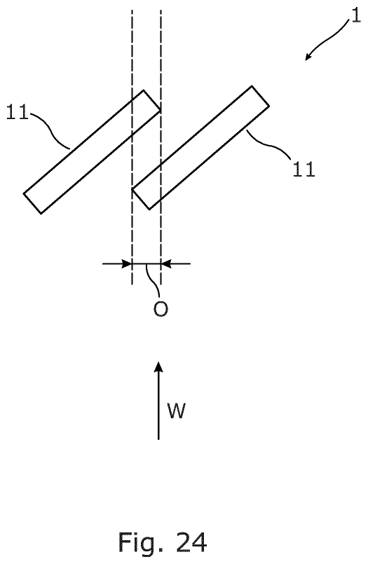

FIG. 24 shows two cooling modules overlapping,

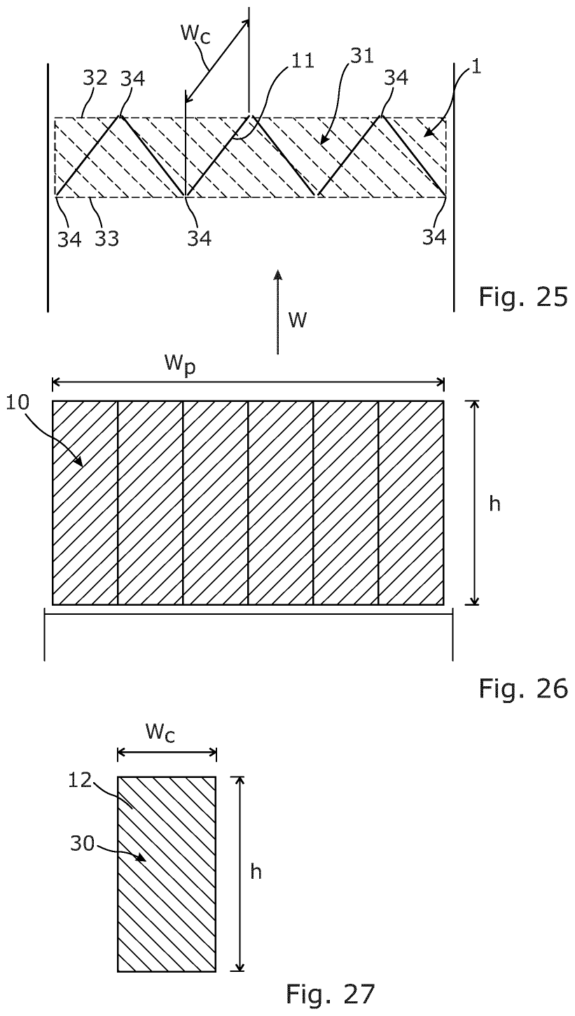

FIGS. 25-27 show an example of calculating the effective cooling area and the projected wind area, and

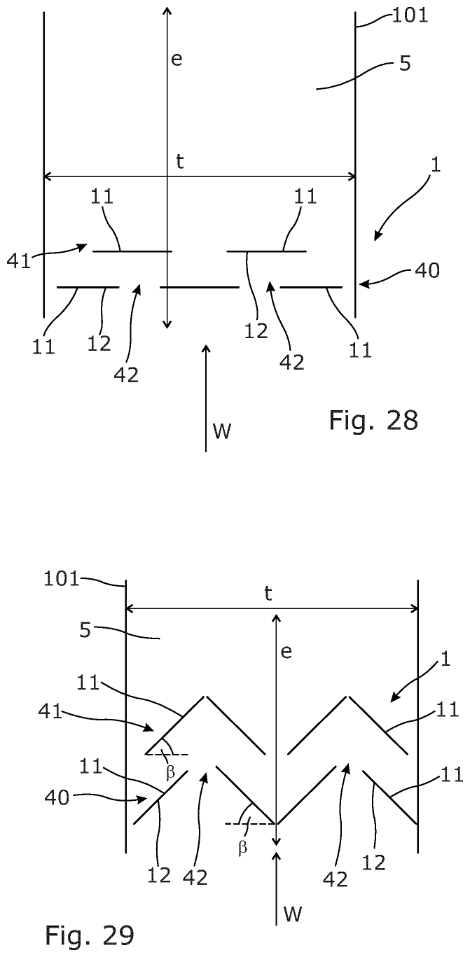

FIGS. 28-29 show other embodiments of the wind turbine mounted cooling system according to the invention.

All the figures are highly schematic and not necessarily to scale, and they show only those parts which are necessary in order to elucidate the invention, other parts being omitted or merely suggested.

FIG. 1 shows a perspective view of a wind turbine 100 comprising a nacelle 101 and a wind turbine nacelle mounted cooling system 1. The nacelle 101 is situated on top of a tower 102 and has a front facing a hub 7 in which a plurality of rotor blades 8, normally three blades, is fastened. The nacelle 101 being rotably connected with the tower 102, so that the nacelle may be positioned in relation to a wind direction w. The wind direction corresponds to the wind direction of the ambient passive wind. The nacelle 101 may house a generator and other components used for driving the conversion process of wind energy to electricity—also called the drive train. When producing electricity, the drive train produces a lot of heat, resulting in a less effective conversion process.

In order to cool the components and other parts of the nacelle, the wind turbine nacelle mounted cooling system 1 is configured to be mounted on a first face 5 of the nacelle 101 of a wind turbine 100. The first face 5 having a longitudinal extension e substantially corresponding to the wind direction w. The first face 5 also has a transverse extension t being perpendicular to the longitudinal extension e.

In the present embodiment, the first face 5 corresponds to a top face of the nacelle 101. In another embodiment, the first face may be one of the side faces of the nacelle. In addition, the wind turbine nacelle mounted cooling system may be mounted on one or more of the top and/or side faces of the nacelle. The wind turbine nacelle mounted cooling system is preferably arranged on a or more face(s) of the nacelle having ambient passive wind flowing.

Ambient passive wind flowing along a longitudinal extension e of the first face 5 of the nacelle 101 flows in through at least one cooling area of the wind turbine nacelle mounted cooling system 1 and cools a fluid within the wind turbine nacelle mounted cooling system circulating through the cooling area. The cooled fluid exchanges heat with parts of the nacelle 101 and/or equipment/components to be cooled. The wind turbine nacelle mounted cooling system may be placed in front of, in the middle of, or in the back of the nacelle 101, and as mentioned both on the top face and/or on the side faces of the nacelle 101.

The present invention will mainly be described in connection with an upwind wind turbine, i.e. a wind turbine where the nacelle 101 is placed downwind from the wind turbine blades 8. However, the invention may also advantageously be implemented in a downwind wind turbine, i.e. a wind turbine where the nacelle is placed upwind from the wind turbine blades.

The present invention is mainly described as the wind turbine nacelle mounted cooling system being a passive cooling system. However, the present invention may also be used in connection with an active wind turbine nacelle mounted cooling system.

The wind turbine nacelle mounted cooling system 1 has a projected wind area 10 when in operation extending substantially in a perpendicular direction from the first face 5, the projected wind area is defined by at least a first cooling module having a first cooling area. In FIG. 2a, a projected wind area 10 is shown as hatched. In the present embodiment, the wind turbine nacelle mounted cooling system 1 comprises six cooling modules arranged adjacent to each other along a transverse extension t of the first face 5. The six cooling modules define a two-dimensional area by projecting its shape on to an arbitrary plane as seen in FIG. 2a, i.e. the projected wind area 10. In the prior art solutions, the projected wind area of the wind turbine nacelle mounted cooling systems correspond to the effective cooling area of the wind turbine nacelle mounted cooling system.

According to the invention, the projected wind area 10 is defined by at least a first cooling module 11 having a first cooling area 12. In FIG. 2b, a wind turbine nacelle mounted cooling system 1 is shown in a top view. The wind direction w substantially corresponds to the longitudinal extension of the first face 5. Normally, the cooling system extends perpendicularly to the wind direction w so that the cooling area of the cooling system extends 90 degrees to the wind direction w as indicated by the angle α in FIG. 2b. At least a part of the first cooling area 12 is arranged with an angle β different from 90 degrees in relation to the longitudinal extension e, i.e. the wind direction w, of the first face 5 of the nacelle 101 as shown in FIG. 2b. In FIG. 2b, the entire first cooling area 12 is arranged with an angle different from 90 degrees in relation to the longitudinal extension, i.e. wind direction w. In FIG. 2b the wind turbine nacelle mounted cooling system is arranged on the top face of the nacelle 101, and the cooling area is arranged with a horizontal angle in relation to the longitudinal extension, i.e. the wind direction w. A height and a width of the first cooling area define an effective cooling area. By angling the first cooling area 12, the effective cooling area of the wind turbine nacelle mounted cooling system 1 is larger than the projected wind area 10, and thereby, the wind turbine nacelle mounted cooling system provides enhanced cooling efficiency. In addition, it may be possible to have additional cooling modules positioned on the first face when one or more of the cooling areas of the cooling modules are angled compared to where the cooling modules were positioned as in the prior art solutions.

FIG. 3 shows an embodiment of the wind turbine nacelle mounted cooling system 1 arranged on the first face 5 of the nacelle 101. The cooling system 1 is arranged at the end of the nacelle being opposite the hub 7. In the present embodiment, a plurality of cooling modules 11 is arranged adjacent to each other in the transverse extension t of the first face 5 of the nacelle 101. The plurality of cooling modules may be a plurality of first and second cooling modules having a first cooling area and a second cooling area, respectively. In the following, the cooling modules will primarily have the reference number 11, and the cooling area will primarily have the reference number 12, irrespective of it may being a first cooling module or a second cooling module, or a first cooling area or a second cooling area. Each cooling module 11 has a cooling area 12, each cooling area having an angle different from 90 degrees in relation to the longitudinal extension, i.e. wind direction w, of the first face 5 of the nacelle 101. In the present embodiment, there are six cooling modules 11 arranged adjacent to each other so that two adjacent cooling modules form a V. By angling all cooling areas 12, it is achieved to have an additional cooling module 11 in the transverse extension t compared to the known solutions whereby the effective cooling area of the wind turbine nacelle mounted cooling system 1 is larger than the projected wind area. Hereby, enhanced cooling capacity compared to known solutions is obtained.

Furthermore, the angle of the cooling areas may be the same of all cooling areas, or it may vary from one cooling area to another so that the transverse extension of the first face is used in an optimal manner.

Also, standard cooling modules may be applied onto the first face with an angle different from 90 degrees in relation to the longitudinal extension, i.e. the wind direction w, of the first face.

FIGS. 4 and 5 show another embodiment of the wind turbine nacelle mounted cooling system 1 arranged on the first face 5 of the nacelle 101. In FIG. 4, the cooling system 1 is shown in a top view, and in FIG. 5, the cooling system is shown in a perspective view. The present embodiment is similar to the embodiment described in relation to FIG. 3; however, in addition to the six cooling modules 11 all having cooling areas 12 being angled in relation to the wind direction w, two additional cooling modules 13 are arranged in the prolongation of the outermost cooling modules. The two additional cooling modules 13 are extending towards the wind direction with an angle different from 90 degrees in relation to the wind direction w.

FIGS. 6 and 7 show another embodiment of the wind turbine nacelle mounted cooling system 1 arranged on the first face 5 of the nacelle 101. In FIG. 6, the cooling system 1 is shown in a top view and in FIG. 7 the cooling system is shown in a perspective view. In the present embodiment, the wind turbine nacelle mounted cooling system 1 comprises six cooling modules 11 arranged adjacent to each other. The cooling modules 11 are arranged so as to substantially provide a semi-circle as seen in FIG. 6. All cooling areas 12 of the cooling modules 11 are arranged with different angles all being different from 90 degrees in relation to the wind direction w.

FIGS. 8-12 show different configurations of the wind turbine nacelle mounted cooling system 1 in a top view. FIG. 8 is similar to the embodiment shown in FIG. 3 wherein six cooling modules 11 are arranged adjacent to each other so that two adjacent cooling modules form a V. The six cooling modules 11 define a zig-zag pattern when seen from above. The wind direction w substantially corresponds to the longitudinal extension of the first face 5. The cooling areas 12 are arranged with an angle different from 90 degrees in relation to the longitudinal extension e, i.e. the wind direction w, of the first face 5 of the nacelle 101 as shown in FIG. 8.

In FIGS. 9 and 10, two different configurations of the wind turbine nacelle mounted cooling system 1 are shown in a top view. In FIG. 9, two additional cooling modules 14 are arranged between the V-configurations of the cooling modules 11 shown in FIG. 8. The additional cooling modules 14 have a smaller cooling area than the adjacent cooling modules 11. In FIG. 10, five additional cooling modules 14 have been arranged between the angled cooling modules 11.

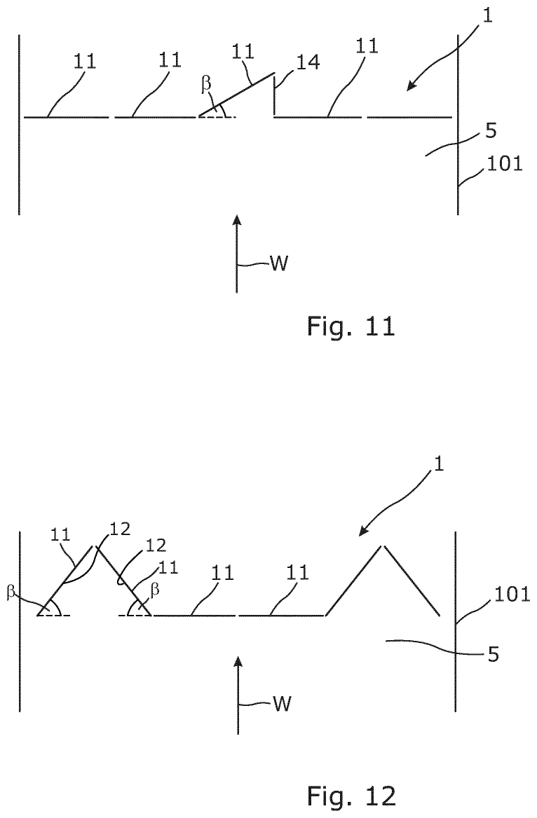

FIG. 11 substantially corresponds to the embodiment described in connection with FIG. 2b. The wind direction w substantially corresponds to the longitudinal extension of the first face 5. The cooling area 12 is arranged with an angle β different from 90 degrees in relation to the longitudinal extension e, i.e. the wind direction w, of the first face 5 of the nacelle 101. In addition, an additional cooling module 14 is in the present embodiment arranged between the angled cooling area 12 and the adjacent cooling module 11. In the present embodiment, the additional cooling area is extending parallelly to the wind direction w thereby capturing the wind and ensures that the wind is directed either through the angled cooling area 12 or the cooling area of the additional cooling module 14.

In FIG. 12, yet another configuration of the wind turbine nacelle mounted cooling system 1 is shown in a top view, where two cooling modules 11 have been arranged between two set of angled cooling modules 11. The wind direction w substantially corresponds to the longitudinal extension of the first face 5. The cooling areas 12 are arranged with an angle β different from 90 degrees in relation to the longitudinal extension, i.e. the wind direction w, of the first face 5 of the nacelle 101 as shown in FIG. 12. Hence, a combination of cooling areas 12 being arranged with an angle β different from 90 degrees in relation to the longitudinal extension, i.e. the wind direction w, and cooling areas being arranged with an agled of 90 degrees in relation to the wind direction are shown.

As indicated, many configurations are feasible by the inventive idea in angling one or more cooling areas of one or more cooling modules. By activating the longitudinal extension of the first face, it is possible to enhance the effective cooling areas of the cooling modules compared to the known solutions wherein the cooling modules are arranged adjacent to each other in the transverse extension of the first face with an angle being 90 degrees to the longitudinal extension, i.e. wind direction w, of the first face. Furthermore, straight lines taken along the extremities of the cooling module(s) together define a three-dimensional volume of the cooling system. Hence, as mentioned above, by activating and utilising a larger volume in the longitudinal extension of the first face, a larger effective cooling area may be provided compared with the known solutions in which only the depth of the cooling modules are occupying space in the longitudinal extension of the first face. Furthermore, it is obtained that standard cooling modules having predetermined sizes may be used and at least one more cooling module may be arranged on the first face by using both the longitudinal and transverse extensions of the first face.

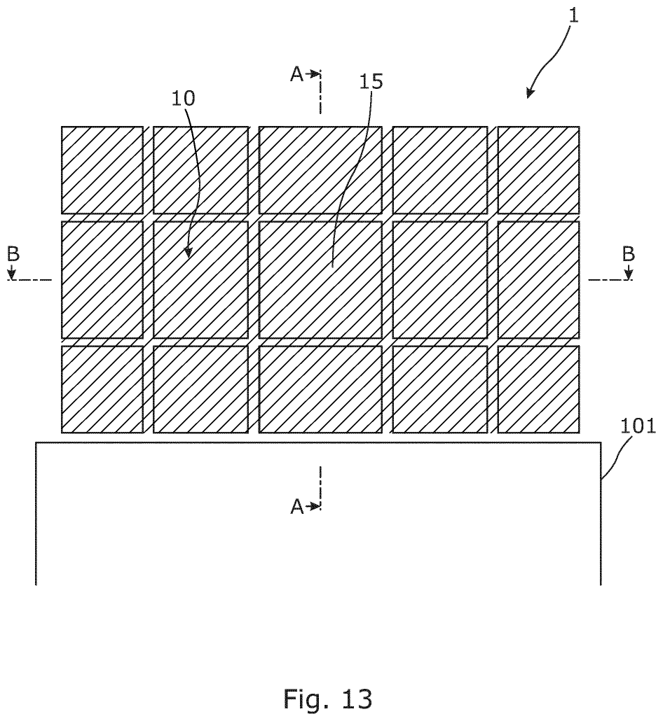

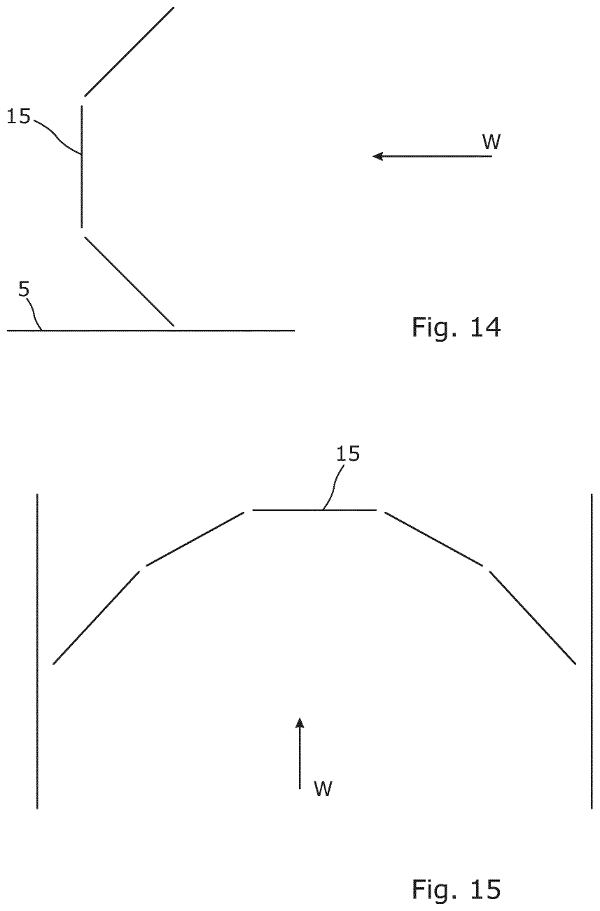

FIGS. 13-15 show another embodiment of wind turbine nacelle mounted cooling system 1. In the present embodiment, the cooling system 1 has partly the form as a satellite dish. In the present embodiment, the cooling system comprises 15 cooling modules each having a cooling area. All cooling areas having an angle being different from 90 degrees in relation to the wind direction except the cooling area 15. In FIG. 13, the projected wind area 10 (i.e. the hatched area) of the wind turbine nacelle mounted cooling system 1 is shown. In FIG. 14, a cross-sectional view is shown along the A-A line in FIG. 13 and in FIG. 15 a cross-sectional view is shown along the B-B line in FIG. 13. FIG. 14 shows a side view the satellite dish and FIG. 15 shows a top view satellite dish.

The first cooling area may have a curved extension, the curved extension having a plurality of tangent lines along the curved extension, each tangent line defining an angle being different from 90 degrees in relation to the longitudinal extension of the first face of the nacelle. In addition, the first cooling area may have a double curved extension.

The first cooling module and the second cooling module may each be connected with the first face. Furthermore, two adjacent cooling modules may be connected to each other by one or more connection parts. Each cooling module may be connected with a cooling circuit configured to circulate a cooling medium so that the cooling medium may flow in the cooling module and the cooling circuit. The different cooling modules may be fluidly connected with each other.

Computational fluid dynamics (CFD) simulation

A CFD simulation has been performed wherein two different configurations of a wind turbine nacelle mounted cooling system according to the present invention have been compared to a known cooling system.

The known cooling system is a standard configuration of cooling modules arranged adjacent to each other in a transverse direction of the nacelle only. Each cooling module has a cooling area arranged perpendicular to the wind direction. Hence, the effective cooling area of the standard configuration is equal to the projected wind area. The standard configuration has 264.2 KW in cooling effect.

The first simulation configuration of the wind turbine nacelle mounted cooling system had a configuration substantially similar to the embodiment shown in FIG. 4 according to the invention. The first simulation configuration had 344 KW in cooling effect.

The second simulation configuration of wind turbine nacelle mounted cooling system had a configuration substantially similar to the embodiment shown in FIG. 3 according to the invention. The second simulation configuration had 333 KW in cooling effect.

Thus, the standard configuration and the first and the second simulation configurations have substantially the same projected wind area. However, the first and the second simulation configurations had considerable larger effective cooling area compared to the standard configuration.

Hence, the first simulation configuration had approximately a 30% increase in effective cooling area compared to the standard configuration, and the second simulation configuration had approximately a 26% increase in effective cooling area compared to the standard configuration.

Accordingly, by applying the present invention it was possible to increase the effective cooling area considerably compared to a standard configuration.

FIGS. 16 and 17 show yet another embodiment of the wind turbine nacelle mounted cooling system 1 arranged on the first face 5 of the nacelle 101. In FIG. 16, the cooling system 1 is shown in a perspective view and in FIG. 17 the cooling system is shown in a top view. In the present embodiment, the wind turbine nacelle mounted cooling system 1 comprises six cooling modules 11 each arranged with a distance between them and each arranged with an angle different from 90 degrees in relation to the longitudinal extension, i.e. the wind direction w, of the first face 5 of the nacelle 101. In the present embodiment, a first set 25 of three cooling modules 11 are arranged with a first angle and a second set 26 of the other three cooling modules 11 are arranged with a second angle so that the first set 25 and the second set 26 together define a funnel 27 as seen in FIG. 17.

FIG. 18 shows a part of a cooling module 11 in a top view. The cooling module 11 comprises at least one heat exchanger core 20 configured to define the cooling area of the cooling module 11, the heat exchanger core 20 having a core extension ec extending from an upwind side to a downwind side of the cooling module, the core extension ec is arranged substantially parallelly to the wind direction w. Hence, the heat exchanger core 20 has in this embodiment an angle different from 90 degrees to the cooling area compared to the prior art solutions wherein the heat exchanger cores are perpendicular to the cooling area.

The cooling module 11 may comprise a plurality of heat exchanger cores 20 as seen in FIG. 18, the plurality of heat exchanger cores 20 are arranged in a row extending along the cooling area. The heat exchanger cores 20 are arranged with a mutual distance between them defining a space between them. In the space, air fins (not shown) may be arranged for enhancing the efficiency of the cooling module.

The air fins may also be arranged substantially parallelly to the wind direction.

In the embodiment shown in FIG. 18, the heat exchanger cores 20 are arranged substantially vertically, however in other not shown embodiments, the heat exchanger cores may be substantially horizontal.

The heat exchanger cores may comprise a fluid tube wherein the cooling medium is configured to flow.

FIG. 19 shows two cooling modules 11 arranged with a mutual angle between them in a top view. The two cooling modules 11 abut each other at a corner of the cooling modules. Each cooling module 11 have a plurality of heat exchanger cores each arranged so they are positioned substantially parallel to the wind direction w.

In the same manner as in FIG. 19, FIG. 20 shows two cooling modules 11 arranged with a mutual angle between them in a top view. Each cooling module 11 has a plurality of heat exchanger cores each arranged so they are positioned substantially parallelly to the wind direction w. Additionally, in the present embodiment, heat exchange cores 20 have been arranged in an area 21 downwind of the abutment corners of the two cooling modules 11, thereby enhancing the cooling efficiency of the cooling area. A CFD simulation of this embodiment indicates an increase of additional 5% in efficiency of the cooling modules 11 compared to the embodiment shown in FIG. 19.

As mentioned previously, standard cooling modules may be used. These standard cooling modules normally have a plurality of heat exchanger cores extending perpendicularly to a transverse cooling extension of the cooling area.

In a top view, FIG. 21 shows another embodiment of the wind turbine nacelle mounted cooling system 1 arranged on the first face 5 of the nacelle 101. In the present embodiment 15, cooling modules 13 are each arranged with a distance between them, and they are each arranged with an angle β different from 90 degrees in relation to the longitudinal extension, i.e. the wind direction w, of the first face 5 of the nacelle 101. They all have the same angle β in relation to the longitudinal extension of the first face 5. In other embodiments, a different numbers of cooling modules may be arranged on the first face of the nacelle.

In a top view, FIG. 22 shows another embodiment of FIG. 21. In this embodiment air guides 30 are arranged between the cooling modules 11. The air guides 30 are arranged so that they extend between two adjacent cooling modules substantially parallelly to the wind direction w. The air guides 30 are configured to lead the ambient wind to the cooling areas of the cooling modules 11 for enhancing the efficiency of each cooling module.

In FIG. 23, another arrangement of air guides 30 are shown. In the present embodiment, the cooling modules are arranged in an overlapping manner when seen from the wind direction w. The air guides 30 extend between two adjacent cooling modules 11. In the present embodiment, the cooling modules 11 are arranged with an angle β to the longitudinal extension of the first face of the nacelle and the wind direction w providing that two adjacent cooling modules, when seen from the wind direction, overlaps. Accordingly, the air guides 30, when extending between two adjacent cooling modules, are arranged with an angle y being different compared to the wind direction w, as indicated in FIG. 23.

In the present embodiments, the air guides 30 extend fully between two adjacent cooling modules. In others not shown embodiments, the air guide may partly extend between two adjacent cooling modules. In the shown embodiments, the air guides have a substantially planar configuration. In other not shown embodiments, the air guides may have a curved configuration.

In addition, other flow enhancing devices may be provided for assisting in leading the flow of air to the cooling areas of the cooling modules.

As mentioned above, two adjacent cooling modules 11 may overlap each other when seen from the wind direction w. In a top view, FIG. 24 shows two cooling modules 11 overlapping when seen from the wind direction w. The two cooling modules 11 are overlapping with an overlapping distance o as indicated in FIG. 24. The overlapping distance o may vary depending on the angle of the cooling modules, their extensions as well as the distance between the cooling modules. In the present embodiment, the overlapping distance o is little, in other not shown embodiments, the overlapping distance may be greater. Hereby, it is obtained that the effective cooling area may be further enhanced while keeping the wind turbine nacelle mounted cooling system 1 compact.

In FIG. 25, the configuration of the wind turbine nacelle mounted cooling system 1 is similar to the one shown in relation to FIG. 8. In FIG. 25, the wind turbine nacelle mounted cooling system 1 is also shown in a top view. One of the cooling modules 11 is shown having a width wc. As mentioned above, the effective cooling area 30 is defined by the height h and the width wc of the cooling area 12 of the cooling module. In FIG. 27, a cooling area 12 is shown wherein the height h and the width wc is shown. Hence, the effective cooling area 30 of the cooling area 12 in FIG. 27 is h multiplied with wc. Thus, in circumstances wherein a plurality of cooling areas is present in the wind turbine nacelle mounted cooling system 1, each effective cooling area of each cooling area is added to the total effective cooling area.

For instance, in the embodiment shown in FIG. 25 six cooling modules 11 are present, each having a cooling area. Hence, the total effective cooling area 30 is then ((h multiplied with wc) multiplied with 6) m². To the contrary, the projected wind area 10, i.e. the hatched area shown in FIG. 26, is defined by the height h of the cooling modules and the total width wₚ of the cooling modules as indicated in

FIG. 26. The projected wind area is then calculated by h multiplied with wₚ. According to the inventive idea, the effective cooling area (defined by ((h multiplied with wc) multiplied with number of cooling areas)) is larger than the projected wind area (defined by h multiplied wₚ).

In FIG. 25, another hatched area 31 is shown. The hatched area 31 is activating the longitudinal extension of the first face whereby it is possible to enhance the total effective cooling areas of the cooling modules compared to the known solutions wherein the cooling modules are arranged adjacent to each other in the transverse extension of the first face with an angle being 90 degrees to the longitudinal extension, i.e. wind direction w, of the first face. Furthermore, the straight lines 32 and 33 taken along the extremities 34 of the cooling module(s) 11 together define a three-dimensional volume of the wind turbine nacelle mounted cooling system 1. In FIG. 25, the three-dimensional volume 31 is shown in a top view. The height h of the cooling modules is also defining the three-dimensional volume 31. Hence, as mentioned above by activating and utilising a larger volume in the longitudinal extension of the first face a larger effective cooling area may be provided compared with the known solutions in which only the depth of the cooling modules is occupying space in the longitudinal extension of the first face.

In FIG. 28, another embodiment of the wind turbine nacelle mounted cooling system 1 is shown in a top view. In the present embodiment, a first row 40 of cooling modules 11 is arranged adjacent to each other in the transverse extension t of the first face 5, and a second row 41 of cooling modules 11 is arranged adjacent to each other in the transverse extension t of the first face 5 in a distance from the first row 40 in the longitudinal extension e of the first face 5. In the present embodiment, each cooling module 11 of each row 40, 41 may have a cooling area 12, each cooling area 12 having an angle being substantially 90 degrees in relation to the longitudinal extension e of the first face 5 of the nacelle 101. Also, the one or more of the cooling modules 11 of the first row 40 may be arranged with a transverse space 42 from an adjacent cooling module so that wind can pass through the transverse space 42 to the subsequent row 41 of cooling modules 11.

As shown in FIG. 28, at least one of cooling modules 11 of the second row 41 may be arranged opposite the transverse space 42 of the first row 40 seen from the wind direction w.

The present embodiment is activating the longitudinal extension e of the first face for providing a larger effective cooling area compared to the projected wind area.

In FIG. 28, three cooling modules 11 are shown in the first row 40 and two cooling modules 11 are shown in the second row 41, however, any suitable numbers of cooling modules may be arranged in each row.

In FIG. 29, another embodiment of the wind turbine nacelle mounted cooling system 1 is shown in a top view. In the present embodiment, a first row 40 of cooling modules 11 is arranged adjacent to each other in the transverse extension t of the first face 5, and a second row 41 of cooling modules 11 is arranged adjacent to each other in the transverse extension t of the first face 5 in a distance from the first row 40 in the longitudinal extension e of the first face 5. In addition, each cooling module 11 of each row 40, 41 may have a cooling area 12, each cooling area 12 having an angle θ different from 90 degrees in relation to the longitudinal extension e of the first face 5 of the nacelle 101.

Also, the one or more of the cooling modules 11 of the first row 40 may be arranged with a transverse space 42 from an adjacent cooling module so that wind can pass through the transverse space 42 to the subsequent row 41 of cooling modules 11.

As shown in FIG. 29, two cooling modules 11 of the second row 41 may be arranged opposite the transverse space 42 of the first row 40 when seen from the wind direction w.

The embodiment shown in FIG. 29 also activates the longitudinal extension e of the first face 5 of the nacelle 101 for providing a larger effective cooling area compared to the projected wind area. Moreover, each cooling module 11 of the first row 40 may have a cooling area, each cooling area having an angle different from 90 degrees in relation to the longitudinal extension of the first face of the nacelle, and each cooling module of the second row 41 may have a cooling area, each cooling area having an angle being substantially 90 degrees in relation to the longitudinal extension of the first face of the nacelle, or vice versa, or a combination thereof.

Moreover, a third row of cooling modules may be arranged adjacent to each other in the transverse extension of the first face in a distance from the second row in the longitudinal extension. In fact, a plurality of rows of the cooling modules may be arranged with a distance between each row in the longitudinal extension of the first face. The distance may be equal between the rows or the distance may vary between the rows.

Additionally, the cooling modules of the first row may have a first height and the cooling modules of the second row may have a second height, the second height being larger than the first height.

Although the invention has been described in the above in connection with preferred embodiments of the invention, it will be evident for a person skilled in the art that several modifications are conceivable without departing from the invention as defined by the following claims.

1. A wind turbine nacelle mounted cooling system configured to be mounted on a first face of a nacelle of a wind turbine, the nacelle being rotably connected with a tower so that the nacelle is positioned in relation to a wind direction, the first face having a longitudinal extension substantially corresponding to the wind direction, the wind turbine nacelle mounted cooling system comprising:
a projected wind area when in operation extending substantially in a perpendicular direction from the first face, the projected wind area is defined by at least a first cooling module having a first cooling area, the projected wind area is defined as a two-dimensional area by projecting a shape of the cooling module on to an arbitrary plane when seen from the wind direction,
wherein at least a part of the first cooling area is arranged with an angle different from 90 degrees in relation to the longitudinal extension of the first face of the nacelle.

2. A wind turbine nacelle mounted cooling system configured to be mounted on a first face of a nacelle of a wind turbine, the nacelle being rotably connected with a tower so that the nacelle is positioned in relation to a wind direction, the first face having a longitudinal extension substantially corresponding to the wind direction, the wind turbine nacelle mounted cooling system comprising:
a projected wind area when in operation extending substantially in a perpendicular direction from the first face, the projected wind area is defined by at least a first cooling module having a first cooling area, the projected wind area is defined as a two-dimensional area by projecting a shape of the cooling module on to an arbitrary plane when seen from the wind direction,
wherein the first cooling area is defined by a height and a width providing an effective cooling area, the effective cooling area being larger than the projected wind area.

3. A wind turbine nacelle mounted cooling system according to claim 1, wherein the first face has a transverse extension being perpendicular to the longitudinal extension, the cooling system comprises a second cooling module having a second cooling area, the first cooling module and the second cooling module being arranged adjacent to each other in the transverse extension.

4. A wind turbine nacelle mounted cooling system according to claim 3, wherein the second cooling area is arranged with an angle different from 90 degrees in relation to the longitudinal extension of the first face of the nacelle.

5. A wind turbine nacelle mounted cooling system according to claim 3, wherein the first cooling area and the second cooling area together define the effective cooling area, the effective cooling area being larger than the projected wind area.

6. A wind turbine nacelle mounted cooling system according to claim 2, wherein the effective cooling area is 3% larger than the projected wind area, preferably 5% larger than the projected wind area, more preferably 10% larger than the projected wind area, most preferably more than 15% larger than the projected wind area.

7. A wind turbine nacelle mounted cooling system according to claim 1, wherein the projected wind area has an angle of substantially 90 degrees in relation to the wind direction, at least a part of the first cooling area is arranged with an angle being different from the angle of the projected wind area.

8. A wind turbine nacelle mounted cooling system according to claim 1, wherein the angle is different from a plane being perpendicular to the longitudinal extension of the first face of the nacelle with between 2 to 88 degrees, preferably between 14 to 86 degrees, more preferably between 20 to 65 degrees.

9. A wind turbine nacelle mounted cooling system according to claim 4, wherein the angle of the first cooling area and the angle of the second cooling area define a mutual angle between the first cooling area and the second cooling area.

10. A wind turbine nacelle mounted cooling system according to claim 1, wherein a plurality of cooling modules is arranged adjacent to each other in the transverse extension of the first face.

11. A wind turbine nacelle mounted cooling system according to claim 9, wherein each cooling module has a cooling area, each cooling area having an angle different from 90 degrees in relation to the longitudinal extension of the first face of the nacelle.

12. A wind turbine nacelle mounted cooling system according to claim 1, wherein a space is created between two adjacent cooling modules, wherein an additional cooling module is arranged in the space.

13. A wind turbine nacelle mounted cooling system according to claim 1, wherein each cooling module is fluidly connected with a cooling circuit configured to circulate a cooling medium so that the cooling medium may flow in the cooling module and the cooling circuit.

14. A wind turbine nacelle mounted cooling system according to claim 1, wherein the cooling system is a passive cooling system.

15. A wind turbine nacelle mounted cooling system according to claim 1, wherein the angle of the cooling area can be adjusted under operation.

16. A wind turbine nacelle mounted cooling system according to claim 1, wherein the first cooling area has a curved extension, the curved extension having a plurality of tangent lines along the curved extension, each tangent line defining an angle being different from 90 degrees in relation to the longitudinal extension of the first face of the nacelle.

17. A wind turbine nacelle mounted cooling system according to claim 1, wherein the cooling module comprises at least one heat exchanger core configured to define the cooling area of the cooling module, the heat exchanger core having a core extension extending from an upwind side to a downwind side, the core extension is arranged substantially parallelly to the wind direction.

18. A wind turbine nacelle mounted cooling system according to claim 3, wherein an air guide is arranged between the first cooling module and the second cooling module.

19. A wind turbine nacelle mounted cooling system according to claim 1, wherein a first row of cooling modules is arranged adjacent to each other in the transverse extension of the first face, and a second row of cooling cooling modules is arranged adjacent to each other in the transverse extension of the first face in a distance from the first row in the longitudinal extension €.

20. A wind turbine having a wind turbine nacelle mounted cooling system according to claim 1.
